(19) United States
(12) Patent Application Publication
(10) Pub. No.: US 2008/0241024 A1
(43) Pub. Date: Oct. 2, 2008

(54) Method for Leaching Metal Sulphide Minerals

(75) Inventors: Marja Riekkola-Vanhanen, Pori (FI); Seppo Heimala, Pori (FI)

Correspondence Address: SMITH-HILL AND BEDELL, P.C., 16100 NW CORNELL ROAD, SUITE 220, BEAVERTON, OR, 97006, US

(73) Assignee: OUTOTEC OYJ, Espoo (FI)

(21) Appl. No.: 12/088,963

(22) PCT Filed: Sep. 26, 2006
(86) PCT No.: PCT/FI06/00313

§ 371 Date: Apr. 2, 2008

(30) Foreign Application Priority Data
Oct. 13, 2005 (FI) 20051031

(51) Int. Cl. C01B 17/20; C22B 3/04

(52) U.S. Cl. 423/27

(57) ABSTRACT

The invention relates to a method for the sulphate-based leaching of metal sulphide minerals, such as chalcopyrite, CuFeS₂, containing ore in atmospheric conditions. It is beneficial for the leaching of metal sulphides that the sulphide to be leached is treated before leaching or at the beginning of leaching with a sulphide salt that is more noble than the sulphide or the components it includes.

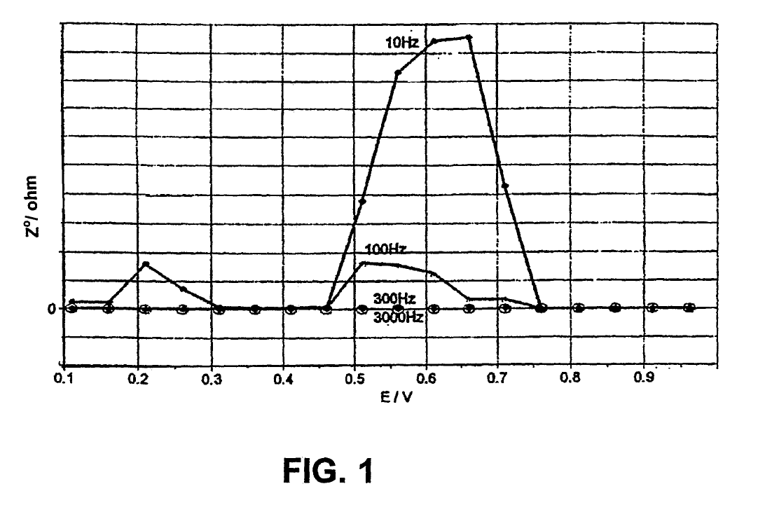

The invention relates to a method for the sulphate-based leaching of metal sulphide minerals, such as chalcopyrite, CuFeS₂, containing ore in atmospheric conditions. It is beneficial for the leaching of metal sulphides that the sulphide to be leached is treated before leaching or at the beginning of leaching with a sulphide salt that is more noble than the sulphide or the components it includes.

The leaching of sulphidic and sulphide-type minerals has been researched for several decades. Specific direct leaching processes for zinc and nickel sulphides have been developed as has one for chalcocite, Cu₂S, but chalcopyrite CuFeS₂ is one of the most difficult metal sulphides to leach. Several methods have been developed for leaching chalcopyrite, which can be classified roughly into three different groups, namely chloride-based methods, bacteria-based or -assisted methods and sulphate based leaching methods at a raised pressure and temperature.

In chloride-based methods, the chalcopyrite leaching takes place mainly by means of divalent copper and trivalent iron, so that soluble metal chlorides, elemental sulphur and iron oxides are formed as the leaching result. Of the subordinate minerals, CuₓS—, (Zn,Fe)S—, PbS— and Fe₁₋ₓS-type minerals dissolve well, but as a rule the dissolving of FeS₂ is modest. One typical chloride-based leaching is the CLEAR process, which is described for example in U.S. Pat. Nos. 3,879,272 and 4,545,972. The copper chloride solution that is formed is routed to a metal recovery stage, which at least includes electrolysis.

One example of bacteria-assisted methods is the process developed by Mintek, which is described for instance in U.S. Pat. No. 6,277,341. In this method chalcopyrite is leached using ferric sulphate and the surface potential of chalcopyrite is adjusted to the empirically determined range between 350-450 mV vs SCE. In addition to the surface potential, the regulating parameters are the leaching temperature (35-80° C.), the pH of the solution and the particle size to which the chalcopyrite is ground. The copper sulphate solution that is formed is routed to extraction and electrolysis to recover the metallic copper. According to WO publication 01/31072, the copper of chalcopyrite is leached by means of bioleaching, where the leaching stage involves dissolved oxygen and carbon dioxide, the sulphides to be leached and micro-organisms.

The leaching of chalcopyrite at raised pressure is described for example in U.S. Pat. No. 3,957,602. In the first stage, chalcopyrite is leached using a copper sulphate solution, with the aim of forming insoluble copper sulphide (digenite Cu_{1,8}S, chalcocite, covellite CuS), soluble ferrous sulphate and sulphuric acid. In the second leaching stage the copper sulphide is made to react with oxygen in the presence of a jarosite-forming cation, resulting in a copper sulphate solution and insoluble jarosite. The disadvantage of the method is that almost all the sulphide of the chalcopyrite is oxidized into sulphuric acid instead of being recovered as elemental sulphur.

Although research has been carried out on the chalcopyrite leaching methods described above for decades, none of them has yet led to production on industrial scale.

When examined closely the chalcopyrite mineral is not the CuFeS₂ mineral given in the formula; in fact its Cu—Fe—S ratios can vary considerably. In addition, as a rule chalcopyrite contains trace elements, at most there may be up to twenty elements, generally to the level of 3%. Since the CuFeS₂ granule to be leached, for example 20 micrometres in size, comprises in the order of 40 000 atom (ion) level, it is understandable that in reality the leaching of CuFeS₂, i.e. the dissolution of the mineral structure is far from just the transfer of copper, iron and sulphur ions of different values (Cu²⁺, Fe²⁺, Cu⁺, Fe³⁺, S²⁻) apart from each other. Additionally, during mineral grinding and/or leaching a sulphur-rich layer can easily be generated on the surface of the chalcopyrite mineral, which is repellent to water and the oxidants in it, thus hampering leaching.

There are usually other minerals in the concentrate with the chalcopyrite to be leached, which contain for instance arsenic, antimony, bismuth, lead, selenium, tellurium and tin along with gold and silver. In leaching, the minerals of these elements also dissolve, and the elements in question may precipitate on the surfaces of the dissolving CuFeS₂ and hinder leaching even further. At worst a powerful chalcopyrite passivation may be generated within as little as one minute from the start of leaching. If the physics and chemistry of the leaching cannot be monitored in real time, the leaching process may stop working or be seriously disrupted without it being possible to identify the reason.

As shown in the description above, there are many factors leading to passivation at work in chalcopyrite leaching, and therefore it is especially necessary that the dissolution of the mineral can be monitored by means of reliable parameters that describe the leaching state. Of course, how the leaching is progressing is monitored and adjusted by means of pH, temperature and Pt redox potential measurements. These do not always, however, give a sufficient picture of the leaching state.

The purpose of the present invention is to eliminate the disadvantages of the methods in the prior art and achieve an improved method for the sulphate-based leaching of metal sulphides. It is beneficial for the leaching of metal sulphides that the sulphide to be leached is brought into contact before leaching or at the start of leaching with the salt of a more noble sulphide compared with the sulphide or component contained in it. Thus for instance chalcopyrite containing ore can be treated with a Cuⁿ⁺ salt. When the mineral to be leached is a sulphide of zinc, nickel or cobalt, a salt forming a more noble sulphide is also in that case a copper salt. The essential features of the invention will be made apparent in the attached claims.

In this method it is also advantageous to recycle at least some of the solution residue back to leaching.

During leaching, the electrochemical potential of the metal sulphide surface is measured as is the change in resistance and capacitance in addition to ordinary control parameters, so that beneficial leaching conditions for the sulphide minerals are determined and can be adjusted.

In the description of the method according to the invention we speak mainly of chalcopyrite leaching, because it is known to be the most difficult of the non-iron metal sulphide minerals to leach, in particular if leaching is sulphate-based. The method according to the invention can however be adapted for the leaching of other metal sulphides.

The invention is described further below, referring to the attached graphical representation 1, which depicts the change in the resistance of the Cu—Fe—S surface as a function of electrochemical potential, measured at several different frequencies. The working electrode used for the potential measurement is a mineral electrode.

As stated above, metal sulphide leaching is delayed for example by the precipitation of iron on the surfaces of the dissolving grains. At the same time sulphur-rich water-resistant layers are formed on these surfaces and the precious metals and silicates in the sulphide mineral may be cemented onto the surfaces. In addition, the reduction of oxygen and transfer of electrons present problems.

The removal of the iron precipitating on the metal sulphide surface can be carried out by bringing the sulphide to be leached into contact with a solution of the kind that contains the salt of a sulphide, which is more noble than the sulphide in question or the components it contains. After this, a controlled leaching is carried out of the layer containing the more noble sulphides (CuₓS, NiₓS) that remain on the surface of the minerals. CuₓS is mainly Cu_{1.96}S mineral, djurleite or Cu₂S, digenite. Tests have revealed that particularly in sulphate solutions the leaching possibilities are easily spoiled right at the start, even before leaching. Regarding chalcopyrite this means that a thin layer of reactive substances such as iron, antimony etc. with the sulphur enrichment on the surface of CuFeS₂ appears before leaching or at the start of leaching. It is very difficult if not impossible to remove this effectively. By treating CuFeS₂ or a like sulphide especially in accordance with the method presented here in controlled conditions with a salt solution forming a more noble sulphide e.g. on a conveyor belt or in a slurry reactor, it has been possible to avoid this interlocking on the sulphide surfaces before leaching, thus ensuring absolutely effective subsequent leaching. The MeₓS that is generated on the surface is leached according to our method so that the surface structure is preserved in MeₓS form.

The addition of complex formers and in this case also the formation in situ causes the dissolution of the surface MeₓS-type sulphide and at markedly lower potentials. At these potentials the dissolution rate of MeₓS is dependent not only on the concentrations of the complexes in question but also above all on the mixing rate and regeneration of the complexes concerned. It was found in a large-scale pilot run, 5 t/h of sulphidic material, that with the method presented here at best the majority of the sulphur in the dissolving sulphides can be released from the dissolving surfaces in separate particles. Since in the leaching conditions of our method, gold complexing sulphur compounds formed largely of soluble sulphides are constantly present at a pH of less than 2, it is natural that precious metals also dissolve and are obtained as co-products in our method, in particular gold and silver. For recovery purposes however, it has been beneficial to remove the gold especially during leaching, so as to keep the Au level of the solution low, at less than 2-5 mg/l depending on the case. When gold is removed at times in between leaching, the kinetic conditions for the further dissolution of gold are improved.

Process conditions are regulated by means of mineral-specific potential and pH adjustments and impedance analyses. Oxygen, air, “tools” forming thiocompounds such as sulphites, bacteria, their additives, catalysts such as nickel and cobalt etc., are used in this control. In this way the maximum leaching rate is maintained and at the same time the passivation of the mineral surface is prevented.

One practical element in the regulation of metal sulphide mineral leaching is the use of a mineral electrode. When operating in this way, one can monitor and control not only the specific redox level of each mineral in the same slurry, but it is also possible to monitor the surface structure and properties of each mineral in relation to successful dissolution. Of course in addition to these measurements, conventional measurement and control parameters are also used such as pH, temperature and concentration measurements of the different elements.

According to the method, an impedance analysis is carried out by measuring the resistance (ΔR) and capacitance (ΔC) of the mineral to be dissolved as a function of the electrochemical potential of the mineral. Measuring the resistance shows the change in the resistance of the mineral surface when different frequencies are used. In a similar way as resistance, measurement data can be obtained on the capacitance of the surface at different frequencies. These data together have proved to give information about the surface structure and welting angle directly from the slurry conditions. If required, the behaviour of different minerals at various points of the leaching reactor, the heap in heap leaching or in another appropriate place can be monitored as a function of the mixing rate for example.

It is beneficial for dissolving the mineral that the resistance is as low as possible and the capacitance as high as possible. A high capacitance signifies that the surface of the mineral is hydrophilic and does not have any coatings harmful to leaching. The resistance and capacitance can be obtained with the same measurement. The appended graphical presentation 1 shows that for instance in chalcopyrite leaching a low resistance range is found between +300-450 mV vs Ag/AgCl. Tests have been made at several different frequencies (10, 100, 300 and 3000 Hz), and the tests made at the smaller frequencies in particular show that there is a low resistance in the above range. The graphic also reveals that the reducing or increasing the leaching strength results in difficulties in leaching. The resistance from the leaching range +750 mV upwards is also low, but the required leaching strength is already so great that operating in this range is not economically viable. In addition leaching at a high potential leads to the oxidation of all the sulphide in the mineral into sulphuric acid. One of the advantages of the method is to leach sulphides so that the sulphur contained in the sulphides is recovered as elemental sulphur, thus avoiding the production of sulphuric acid.

The method according to the invention is used to study each sulphide mineral under different conditions i.e. using different temperatures, different pH values, various reagent concentrations and performing resistance and capacitance measurements on these different variations as a function of potential. By doing this to each mineral a suitable “leaching corridor” or “window” can be found, i.e. an operating area, which is the most advantageous for said mineral. It has been proved on the basis of measurements that many variables have multiple effects. Thus some reagents used in leaching regulation such as SO₂ or elements in minerals that behave like catalysts such as cobalt, nickel, silver, iron or antimony have different effects at different concentrations.

The fact that reagents have different effects as conditions change, is probably a consequence of the formation of new surface phases such as (Cu,Ni,Fe)ₓS on the surface of the dissolving mineral or due to the complicated interdependencies of the various elements. With the method according to the invention however, now the behaviour of different sulphide minerals can be monitored in real-time conditions mineral by mineral. In this way for example the right conditions can be formulated for chalcopyrite leaching for example and leaching can be prevented from entering a range susceptible to disruption.

Suitable reagents such as elements that form sulphur complexes are used to adjust leaching to the correct range. These elements are thiosulphate ions, polythionate ions or various kinds of sulphide ions, such as thiourea-type compounds in small concentrations, typically 10-50 mg/l. When determining a suitable leaching range for each mineral, it is advantageous to make the measurements described above in advance directly from the slurry with different reagents at different concentration as well as varying the temperature and pH values, and in this way a suitable range for leaching is formulated for each mineral.

Sulphur dioxide, sulfites, controlled oxygen pressure, bacteria, carbon or other elements with a catalytic effect on sulphur and sulphide reactions can be used for leaching control.

It is beneficial to perform the leaching of metal sulphides, in particular copper, nickel, zinc and cobalt sulphides, in a pH range where iron can be precipitated directly in oxide form during leaching. Usually this means FeOOH and Fe₂O₃. However, in order to manage the sulphate balances it is advantageous to precipitate part or all of the iron as jarosite, whereupon leaching is carried out at the corresponding pH values. It is beneficial to return at least part of the leaching residue to the leaching stage to stablise the redox levels, to form a nucleus for the precipitating phases and to control the complex chemistry.

Post-leaching solution purification is carried out using sulphide- or selenide-forming minerals such as Fe—S or MnS system minerals which are less noble than the element to be removed.

The sulphate solution exiting mineral leaching that contains valuable metals is typically routed to liquid-liquid extraction and electrolysis to form a metal product.

Another alternative is to perform conversion on the resulting sulphate solution, which contains a valuable metal. In conversion the sulphate solution is routed to the conversion stage, which occurs at a temperature between 90-200° C. and in which the sulphate solution is treated for instance with chalcopyrite, whereupon CuₓS concentrate is obtained. The sulphide concentrate obtained is routed either to hydro- or pyrometallurgical processing. Conversion is described for instance in WO publication 2005/007902.

The method according to the invention can also be combined with various sulphide mineral bacteria-assisted leaching or bioleaching. According to the prior art it is important to know which species of bacteria suits the leaching of a certain sulphide. However, we have now found that it is not a question of certain bacteria species but rather how the bacteria population in question can produce an active space and corresponding structure on the surface of the dissolving sulphide. During the bioleaching of chalcopyrite and also pentlandite (Ni,Fe)₉S₈ we have found that this means a surface poor in sulphur, which has not even been enriched by iron. This is due to the effect of the sulphur-based complexes mentioned above. In measurements this has appeared as a very small reaction resistance (ΔR) and simultaneously as a high hydrophilicity (as a corresponding ΔC i.e. capacitance value) at certain mineral redox value ranges. Thus the effect achieved by bacteria is also achieved in the method according to this invention by the “inorganic” means described either separately or together with the use of bacteria.

The invention is described further by means of the examples below.

### EXAMPLES

### Example 1 (Reference Example)

Chalcopyrite concentrate was ground in a ball mill to a fineness of 80% −37 μm. It was leached in sulphate-based leaching by means of oxygen at a temperature of 97-101° C. The pH value was adjusted to between 1.5-1.7 and the Fe²⁺+Fe³⁺ content was in the region of 15-28 g/l. The yield of copper into the solution was 36.5% after 20 h and 68.3% after 50 h, when the redox potential was in the region of +505-+565 mV vs. SCE.

### Example 2

A solid, ground as in Example 1, was leached at a temperature range of 97-101° C. using oxygen at two different pH values, where the first was between 1.5-1.7 and the second was between 2.1-2.35. In both tests 10 g/l of copper as copper sulphate as the more noble sulphide salt was added to the starting solution. In the early stage there was 24 g/l of dissolved Fe²⁺ and 30 g/l of jarosite nuclei in the more acidic solution, whereas in the solution with the higher pH the nucleus was 75 g/l FeOOH and Fe₂O₃. Both solutions contained 140 mg/l of chloride as impurities. In addition, the solution contained 400 mg/l of thiosulphate and 10 g/l of powdered carbon as control reagents.

In both tests leaching was started by utilizing the following typical reactions:

CuFeS₂+(Cu²⁺, Cu⁺)→CuₓS+Fe²⁺+ . . .

In both tests oxygen and sulphur dioxide were fed into the solution on the basis of the most advantageous operating area that had been found in previous electrochemical tests using mineral electrodes and by making impedance analyses to determine the resistance and capacitance of chalcopyrite as a function of redox potential. In this way it was possible to determine that the preferred redox potential was tens of millivolts smaller than that used in test 1. At the same time the tests proved that chalcopyrite dissolved in that case to a large extent through the medium of the CuₓS surface phase forming on the surface of the mineral. The chalcopyrite potential of +365-+475 mV vs SCE and +385-+435 mV vs SCE at corresponding pH values of 1.5-1.7 and 2.1-2.35 were chosen for the test conditions.

At the lower pH test value, the same mixing was used as in example 1 and at the higher pH value the mixing was carried out with a static mixer and flow. The test results of the copper leaching yields were as follows:

| | 20 h | 50 h |
|---|---|---|
| pH 1.5-1.7 | 71.4% | 97.1% |
| pH 2.1-2.35 | 98.1% | 99.6% |

The gold leaching yield in the higher pH range leaching was over 90%, thanks to the formation of S—O—Au complexes.

### Example 3

Heap leaching was performed on chalcopyrite in pieces. A pyritic ore, which contained 0.57% copper as chalcopyrite and with a particle size of less than 12 mm, was leached into a sulphate solution with bacterial assistance. The heap was formed into layers replicating a four-metre heap. New ore and old leach residue was mixed into the ore to be leached in a weight ratio of 3:1. The new ore was treated with sulphuric acid-copper sulphate leaching before mixing and making the heap.

The leaching of the chalcopyrite in the heap was regulated by keeping the heap conditions within the range of the solubility window that was determined from the mineral electrode, resistance and capacitance measurements. Regulation was performed with the aid of air feed, sulphite addition and the measurements and steps usually involved in heap leaching, such as pH and temperature regulation or addition of bacteria. This meant that the oxidation power had to be restricted considerably from the area usually used in the heap leaching of porphyritic copper ores of +565-665 mV vs. SCE to the region of +300-+470 mV.

As a result of leaching, 74.5% of the copper was recovered over eight months and a total of 83.9% of the copper contained in the heap was recovered in twelve months. The excellent recovery was due to the fact that it was possible to prevent the precipitation of iron on the surface of the chalcopyrite and thus the surface remained active.

1-21. (canceled)

22. A method for the leaching of metal sulphide minerals in atmospheric conditions, wherein the leaching of the metal sulphide mineral is sulphate-based and that the sulphide to be leached is brought into contact with a sulphide salt that is more noble than the sulphide or a component of it, either before leaching or at the start of leaching, and that impedance analysis is carried out by measuring the resistance and capacitance of the mineral to be dissolved as a function of the electrochemical potential of the mineral.

23. A method according to claim 22, wherein the sulphide to be leached is brought into contact with a sulphide salt solution that is more noble than the sulphide or its component.

24. A method according to claim 22, wherein the sulphide mineral is treated with a Cuⁿ⁺ salt.

25. A method according to claim 24, wherein the copper salt is copper sulphate.

26. A method according to claim 22, wherein the metal sulphide mineral is chalcopyrite.

27. A method according to claim 22, wherein the sulphide to be leached is at least one of the following: nickel, zinc and cobalt sulphide.

28. A method according to claim 22, wherein the treatment of the sulphide to be leached with a more noble sulphide salt takes place in a slurry reactor.

29. A method according to claim 22, wherein the treatment of the sulphide to be leached with a more noble sulphide salt takes place on a conveyor belt.

30. A method according to claim 22, wherein the precious metals, such as gold, that dissolve during sulphide treatment are recovered from the solution.

31. A method according to claim 22, wherein the electrochemical potential of the surface of the metal sulphide is measured during leaching by means of a mineral electrode.

32. A method according to claim 22, wherein before leaching, the sulphide to be leached is studied at different temperatures, pH values and reagent contents and that the different variations undergo resistance and capacitance measurements as a function of the potential.

33. A method according to claim 32, wherein the leaching of the metal sulphide is regulated to occur within the specified preferred operating range by means of resistance and capacitance measurements

34. A method according to claim 22, wherein the reagent used in leaching regulation is at least one of the elements that form sulphur complexes.

35. A method according to claim 34, wherein the reagent used is at least one of the elements: a thiosulphate ion, polythionate ion or sulphide ion like thiourea.

36. A method according to claim 22, wherein at least one of the following is used for leaching regulation: sulphur dioxide, sulphite, controlled oxygen pressure, bacteria, carbon, some other element that has a catalytic effect on sulphur and sulphide reactions.

37. A method according to claim 22, wherein the iron contained in the metal sulphide mineral is precipitated during leaching as an oxide.

38. A method according to claim 22, wherein the sulphur contained in the metal sulphide mineral is precipitated during leaching as elemental sulphur.

39. A method according to claim 22, wherein at least part of the dissolution residue of the leaching is circulated back to leaching

40. A method according to claim 22, wherein the solution obtained from metal sulphide mineral leaching is routed to liquid-liquid extraction and electrolysis to fabricate a pure metal.

41. A method according to claim 22, wherein the solution obtained from metal sulphide mineral leaching undergoes conversion, and the metal sulphide generated is routed to hydrometallurgical processing to fabricate a pure metal.

42. A method according to claim 22, wherein the solution obtained from metal sulphide mineral leaching undergoes conversion, and the metal sulphide generated is routed to pyrometallurgical processing to fabricate a pure metal.
